(19) United States
(12) Patent Application Publication
(10) Pub. No.: US 2010/0275856 A1
(43) Pub. Date: Nov. 4, 2010

(54) Pinch-Induced Behavioral Inhibition in Domestic Cats

(76) Inventors: Charles A. Buffington, Worthington, OH (US); Judi L. Stella, Carroll, OH (US); Sue Wagner, Worthington, OH (US); Megan Pozza, Columbus, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/835,012

(22) Filed: Jul. 13, 2010

Related U.S. Application Data
(62) Division of application No. 12/048,470, filed on Mar. 14, 2008.

(51) Int. Cl. A01K 29/00

(52) U.S. Cl. 119/712

(57) ABSTRACT

A clip device that pinch induces a behavior inhibition response in a mammal by means of two jaws that close to form a skin fold loop. The clips device provides manual scruffing by means of gathering skin between the two jaws such that internal surfaces of the skin structure are in juxtaposition to each other and external surfaces of a mammal's skin are at interfaces to the jaws. The clip device is placed on the mammal's neck region or its tail head at a non-noxious pressure between systolic and diastolic blood pressure. The clip device induces a passive response from a mammal so a procedure can be performed on the mammal with two free hands of a user.

### RELATED APPLICATIONS

This application is a Divisional Application of U.S. Ser. No. 12/048,470, filed on Mar. 14, 2008 and claims a benefit of both U.S. Provisional Application No. 60/918,794, filed on Mar. 20, 2007 and U.S. Provisional No. 60/945,238 filed on Jun. 20, 2007, both incorporated by reference as if it is fully rewritten herein.

### BACKGROUND OF THE INVENTION

1. Field of the Invention

The present invention relates to a manual scruffing clip device and, more specifically, to a clip that is applied to the scruff of a neck to pinch-induce a behavior inhibition response.

2. Description of the Related Art

It is recorded as early as 1646 that a practice of animal hypnosis was known to the ancient Egyptians. Animal hypnosis is a spectrum of immobility behaviors demonstrated in the animals of a variety of taxa, including, e.g., insects, reptiles, birds and mammals. Animal hypnosis describes a behavioral state in which an animal is both immobilized and desensitized to external stimuli. Immobility is assumed to have a survival value in nature because many instances of its occurrence are found in the wild: deer freeze when they are caught in headlights of oncoming vehicles; snakes transfix the gaze of their prey; and, baby mammals limp when they are picked up by their necks with their mother's jaws. Although the mechanisms are quite distinct, all of the foregoing behaviors describe an induction of immobilization by an external stimuli. A variety of terms are used to describe the behavior because of the many ways to induce immobilization: “hypnosis”, “scruff immobility reflex”, “behavioral arrest”, “bewitchment”, “fascination” and “death feigning”.

There is significant interest in a research of immobilization through mechanical inhibition in mice, rats, rabbits and guinea pigs. Immobility responses are typically induced in these animals using neck clips or inversions. There is little research on immobilization in cats, but success is noted when clips are placed along cats' dorsal midline. Cats are also immobilized when clips are placed along their neck or back. Cats pinch-induced behavioral inhibition (also known as “clipnosis”, but hereinafter referred to as “PIBI”) is a response that differs from true animal hypnosis because the cats are not fully immobilized by the clips; rather, they retain some mobility with a decreased response to external stimuli.

This phenomenon is currently not widely recognized as a safe and a useful form of restraint for cats; however, the present invention teaches beneficial clinical applications of PIBI for cats diagnosed with feline idiopathic cystitis (hereinafter “FIC”). Cats with FIC are unusually sensitive to stressors and restraint.

A scruff response in kittens is an immobility caused by its mother picking it up by the loose skin of the neck and carrying it. The kitten's tail curls under its body, its back ventroflexes and the kitten becomes passive. This scruff response persists through adulthood, as can be seen during mating when a tom grasps the scruff of a queen to immobilize her while he mounts. Veterinarians and cat owners have long recognized that “scruffing” a cat provides an effective restraint for minor procedures such as an administering of injections, a trimming of claws, a physical examination, wound care, venipuncture, a vaccination, glucose monitoring, etc. The present invention teaches a means on manually scruff a cat in the form of a clip that is applied to the scruff of its neck to induce a comparably passive behavior.

### SUMMARY OF THE INVENTION

It is an object of the present invention to teach a means to pinch-induce a behavior inhibition response in a cat or another mammal (s.a., a dog, a ferret, a rat, a rabbit, a guinea pig, a hamster, a mouse, etc.). It is an object that the present means is a clip device that is used for manual scruffing. It is a further object that the PIBI response effectively inhibits the cat's mobility during a phlebotomy, veterinary procedures and other minor procedures. It is an object that the clipping taught herein is administered before procedures in clinical settings; but, it is an object that the present means induce a relaxing effect on cats even after clips are removed.

It is an object of the present invention to elicit a complacency response in a mammal without decreasing an ability of a care giver from effectively performing manual operations. It is an object of the present invention to free a person's hand or finger required for common manual scruffing. It is a further object that the present clip is a safer and a more effective alternative to anesthesia, physical and chemical restraint methods.

It is an object that the present invention induce comparable responses to that of scruffing, s.a., e.g., miosis, ventroflexion of the back, a tail curled under the body. It is another object that the clips stimulate PIBI responses in cats at locations other than the scruff. It is an object that the clips are placed anywhere along the dorsal midline of the cat. It is an object that a stimulation of points along the dorsal midline (a.k.a., “the governing vessel meridian”), especially at GV 14, decrease hyperactivity. In the preferred embodiment, maximum clip effectiveness is induced when clips are applied to the neck.

It is an object that the present clip is a strong clip capable of effectively producing the greatest pressures because clip pressures dramatically effect PIBI induction. It is an object that the clip pressure is non-noxious and between systolic and diastolic blood pressures to ensure that the clip's application does not injure the animal. It is an object that the clips are not capable of applying high pressures (>300 mmHg) for prolonged periods of time (i.e., hours) to avoid inducing ischemia-related injuries.

It is an object that the present clip creates a hands-free mechanical device that elicits reduced mobility in a cat, wherein it frees a person's hands to carry out other necessary procedures on the cat.

It is envisioned that the present clipping device grasps a mammal's skin between two opposable grasping surfaces. Skin structure is gathered between two grasping surfaces of the device such that the internal surfaces of the skin structure are in juxtaposition to each other and the external surfaces of the animal's skin structure are at the interfaces of the opposable grasping surfaces of the device.

### BRIEF DESCRIPTION OF THE DRAWINGS

The advantages and the features of the present invention will become better understood with reference to the following more detailed description and claims taken in conjunction with the accompanying drawings, in which like elements are identified with like symbols, and in which:

FIG. 1 is a diagram that shows how the forebrain governs an animal's responses under normal conditions and under stress and fear;

FIG. 2 is an elevational front-side view of the clipnosis device, wherein the jaws are in an open position;

FIG. 3 is an elevational front-side view of clipnosis device of FIG. 2, wherein the arms are in an up position and the jaws are in a closed position;

FIG. 4 is an elevational front-side view of the clipnosis device of FIGS. 2 and 3, wherein the arms are in a down position and the jaws are in a in a closed;

FIG. 5 is an elevational underside view of the jaw of the clipnosis device;

FIG. 6 is a top side view of the clipnosis device, wherein a lengthwise portion of the device is shown;

FIG. 7 is a side view of the clipnosis device;

FIG. 8 is a front view of the clipnosis device;

FIGS. 9 and 10 show a placement of clips along the dorsal cervical region of a cat;

FIG. 11 is a table that shows a breadth of applicability of the clipnosis device on a variety of different animal species.

FIG. 12 shows the effects of repeated clipping on response in healthy and FIC cats; and,

FIG. 13 is a chart that shows a regression of response to scruffing onto a response of clipping in both healthy and FIC cats.

### DESCRIPTION OF THE PREFERRED EMBODIMENTS

The best mode for carrying out the invention is presented in terms of its preferred embodiment, herein depicted within the Figures.

### 1. Detailed Description of the Figures

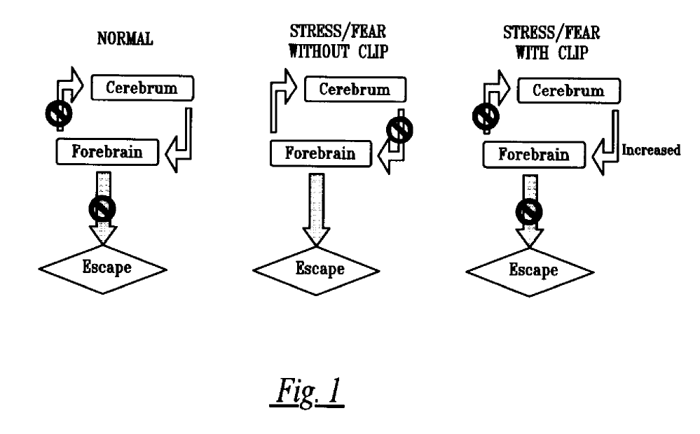

Animals respond to stress and fear in one of three ways: freezing, fight or flight. These responses are believed to be governed by the forebrain, which acts to alter motor activity. Under normal conditions, the cerebrum inhibits an action of the forebrain and the forebrain inhibits subcortical structures. The cerebrum no longer inhibits the forebrain when an animal is frightened, so the animal responds to the stressor. FIG. 1 diagrams the foregoing response.

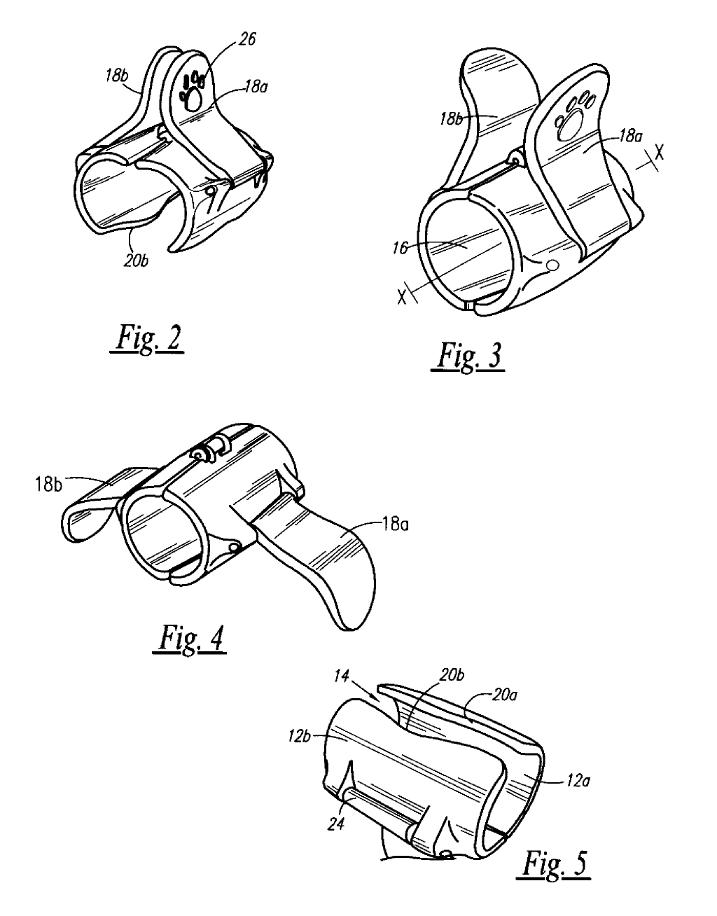

The present invention is a clipping device 10 (hereinafter also referred to as “clipnosis device”) that induces that same response in the forebrain. A clipping device 10 according to the present invention is shown in FIGS. 2-8. The clipping device 10 grasps a mammal's skin between two opposable grasping surfaces 12a, 12b, or jaws. The grasping surfaces 12a, 12b are concavely shaped jaws hingedly adjoined along a first length and capable of grabbing skin along their opposing lengths. Skin structure is gathered between the two grasping surfaces 12a, 12b of the clipnosis device 10 such that the internal surfaces of the skin structure are in juxtaposition to each other and the external surfaces of the animal's skin structure are at the interfaces 14 of the opposable grasping surfaces 12a, 12b of the device. The gathered skin fold loop 16 is not limited to any one size; rather, it may vary in size according to the size of the mammal. Similarly, the related size and configuration of the clipnosis device 10 can be configured for each mammal. Larger mammals require larger skin fold loops 16. It is anticipated that a skin fold loop 10 measures at least 0.5 inches for kittens, at least 1.0 inches for moderate sized cats and at least 1.5 inches for larger cats.

The clipnosis device 10 can be applied alone or in combination with alternate behavioral devices. Additionally, a plurality of same or different sized devices maybe used in series along an animal's back. FIG. 9 shows a placement of clips along the dorsal cervical region of a cat. It is preferred that at least two clip devices 10 are used for larger animals. For an optimal response, the clips 10 are placed in either one or both of two areas: the neck and the tail head. A plurality of clip devices 10 can be applied along the entire length of the animal's back; however, the neck area is more preferred. It is preferred that the clip 10 is placed in the neck region from C1 to C7. It is preferred that the clip is placed in the tail region from L5 to S3.

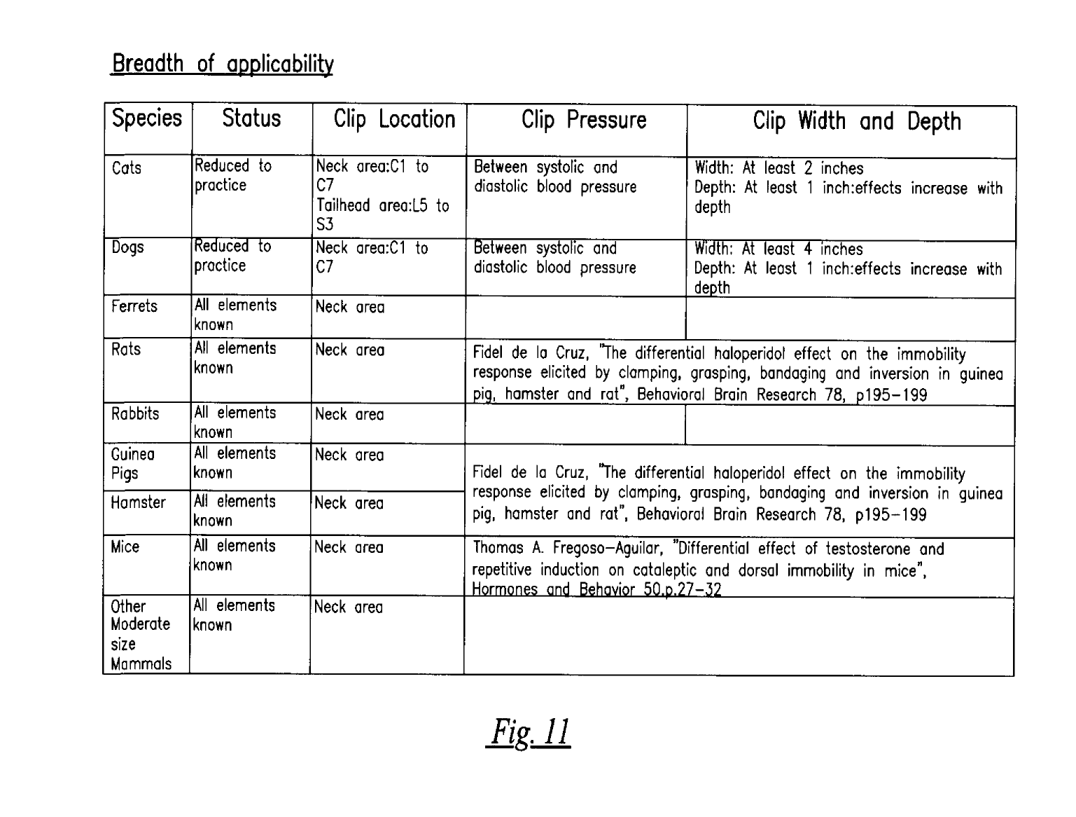

A length is measured from a mammal's head to its tail. The length of the grasped area approximates four inches if a two inch (lengthwise) clipnosis device 10 is utilized. The length doesn't cover the entire C1 to C7 area; rather, it covers the length of the neck and a bit over the shoulder blade. If the clip device 10 is rather placed on the tail head of the animal, its placement begins at a connection of the tail to the body. A plurality of clip devices 10 are placed successively toward the neck. FIG. 11 is a table that shows a breadth of applicability of the clipnosis device 10 on different species of animals.

An application of the clips 10 is achieved by lifting the mammal's skin while sliding the device onto the skin that has been lifted. The clip device 10 mechanically applies the required pressure. The clipnosis device 10 can have a variety of forms, but in all cases, the grasping jaws 12a, 12b first open (FIG. 2) to allow the skin fold loop's placement within the device and then they close (FIGS. 2 and 3) to apply the required pressure on the skin.

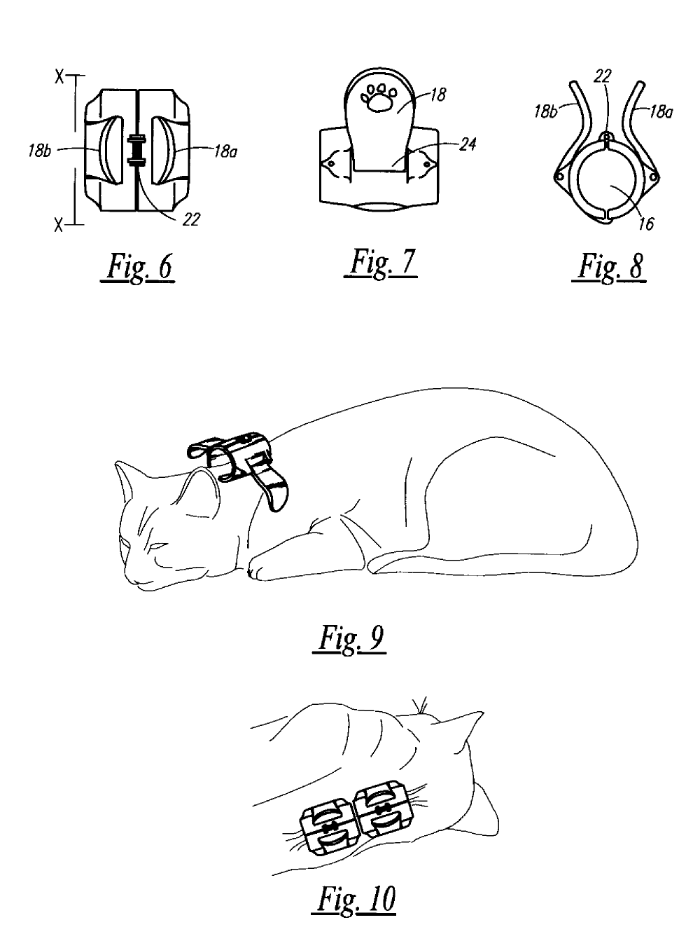

In the preferred embodiment, the clip 10 is a simple compression device having at least one, but preferably two, arm(s) 18a, 18b respectively attached to the outer surface of the jaws 12a, 12b by a hinge 24. The hinge 24 is centrally located along a length of the jaws 12a, 12b. The grasping arms 18a, 18b bend inwards at their centers such that the clipnosis device 10 also hugs a bit of the shoulder blade when the arms are in a down position (FIGS. 4 and 9). The clip device 10 may comprise padding (not shown) or a textured surface 26 along the grip portions to comfort the user. The interface edges 20a, 20b of the gripping surfaces 12a, 12b are textured to facilitate a grip on the mammal's skin. FIGS. 2 and 6 show a slight smooth ripple along the edges 20a, 20b of the jaw gripping surface 12a, 12b. Dull teeth (not shown) may also be comprised on the clip device 10 to better grip the surface on the mammal's skin. An alternative embodiment (not shown) of the clip device 10 rather comprises a mechanism similar to a vise in which a screw engages once the device is in place to lock the clip onto the desired location.

The clip device 10 is applied with its lengthwise axis X-X along the mammal's back or 90° to the mammal's back (refer to FIG. 9). The amount of skin fold loop grasped by the clip device 10 varies and can be more or less, depending upon the amount of skin available to the device. The clipnosis device 10 grasps the skin dorsally to ventrally.

A closure of the clip 10 can be achieved by a variety of mechanical means, s.a., a screw mechanism, a spring mechanism 22 and the like. The two opposable grasping surfaces are bound to each other by any variety of binding means having vertical and/or horizontal configurations. The clip 10 is easily placed on an animal by the user by mounting at least one arm to the two opposable grasping surfaces. Upon a removal of the device, the skin structures return to a pre-grasp configuration and the behavioral inhibition is reversed.

It is anticipated that the clip devise 10 is grasped on the animal for a desired length of time between five and ten minutes; however, it can be applied for longer periods without causing ill effects to the animal's nervous system.

It is further envisioned that the clip device 10 is manufactured from materials that include plastics, rubbers, metals, woods, composites, aluminum, etc. The present clip 10 is a strong clip capable of effectively producing a non-noxious clip pressure between systolic and diastolic blood pressures to ensure that the clip's application does not injure the animal.

### Experiment:

Five (5) healthy male and eight healthy (8) female neutered cats ranging in age from 1 to 5 years and eleven (11) male and seven (7) female neutered cats ranging in age from 1 to 10 years and having FIC were studied (hereinafter referred to “FIC cats”). Two standard two-inch binder clips were used to induce a PIBI response. To ensure that the clips did not induce pressure necrosis, they were applied to a #3 blood pressure cuff inflated to approximately 10 mmHg as the pressure rise was recorded. FIG. 10 shows the clips placed along a dorsal midline from C₁ to C₇. A first clip was placed directly behind the ears, also known as the scruff area which is commonly used by queens to pick up and carry kittens. A second clip was placed immediately behind the first. During an experimentation of the foregoing procedure, a PIBI was immediately ranked on a Likert scale after the second clip was placed on the cat: a ranking of −3 indicated a negative response to the clips, i.e., arousal, vocalization, biting, attempts to remove the clip, etc.; a 0 indicated no response; and, a +3 indicated a marked positive immobilization response, i.e., a catatonic state, a relaxed state, etc.

All of the cats were clipped again at one, two and three month(s) after their initial clipping. PIBI responses were compared to the previous month's ranking. In the fourth month, 12 of the healthy cats and sixteen of the FIC cats were gently lifted by the scruff of their necks to determine if the cat's response to scruffing predicts their response to PIBI using the same scale for ranking. Four of the healthy cats (2 males and 2 females) and 6 of the FIC cats (3/3 male-female) were examined before and during their clipping by a board certified neurologist. Mentation, menace response, facial sensation and front and back leg support capabilities were examined.

A response to PIBI over time was evaluated using the Kruskal-Wallis test. Scruffing and clipping were evaluated using linear regression analysis and an effect of clipping on all neurological parameters was evaluated using the Wilcoxon Signed Rank Test.

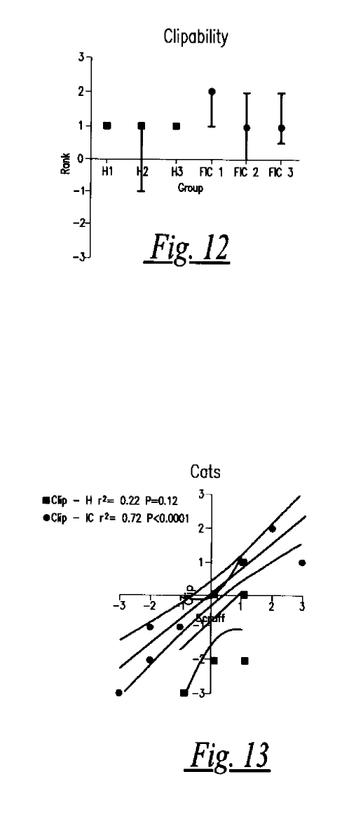

A measurement of pressure applied by clips ranged from 140-160 mmHg. On the initial exposure, 12 healthy cats (92%) had a positive PIBI score and the last (1) cat had a moderate-negative score (−2). All 18 FIC cats (100%) had a positive PIBI score. There were no effects identified in either group for ages or genders. The PIBI score-effects of repeated clipping in healthy cats and FIC cats is shown in FIG. 12. PIBI scores increased in the second month for 7 of the healthy cats, remained the same for 4 cats and decreased for 2 cats. Those scores increased for 3 of the FIC cats, remained the same for 5 and decreased from 10. In the third month, PIBI scores increased in 2 cats, remained the same for 6 and decreased for five. In that same month, scores increased from 5 FIC cats, remained the same for 10 and decreased for 3. As shown in FIG. 12, only the effects for the second month on healthy cats and the first month of FIC cats statistically differ.

Scruffing scores correlated with PIBI scores: a positive scruffing score almost always indicated a positive PIBI score and a same for negative scores. FIG. 13 shows a closer relationship between scruffing and clipping observed in FIC cats verses healthy cats.

No neurological differences were observed in responses of healthy and FIC cats between genders; hence, the data was pooled. Mentation significantly decreased by PIBI (25^{th} percentile=2; median=2; 75^{th} percentile=1; P=0.004). Miosis was observed in all the cats during the clip application. A decrease in mentation was observed in cats after an application of the clips, which suggests a forebrain site of action; however, the altered mentation was not characteristic of decreased arousability. The difference was rather in content; the changes were appropriate to the environment, i.e., more active behavior was observed without the clips. The mentation change appeared to associate with positive characteristics, wherein the cats were calmer, purred and kneaded their paw while the clips were attached. The menace response was decreased or absent in the cats having the most pronounced responses. This further supports forebrain localization of the effect.

The foregoing descriptions of specific embodiments of the present invention have been presented for the purposes of illustration and description. They are neither intended to be exhaustive nor to limit the invention to the precise forms disclosed, and obviously, many modifications and variations are possible in light of the above teaching. The embodiments were chosen and described in order to best explain the principles of the invention and its practical application, to thereby enable others skilled in the art to best utilize the invention and its various embodiments with various modifications as are suited to the particular use contemplated. It is intended that the scope of the invention be defined most broadly by the specifications and the figures appended hereto and their equivalents. Therefore, the scope of the invention is to not to be limited by the following claims.

What is claimed is:

1. A method of inducing behavioral inhibition in domestic felines by placement of one or more pressure-applying clips to hide along the dorsal midline from C1 to C7, wherein at least one pressure-applying clip is placed directly behind the ears, and wherein the pressure-applying clips apply non-noxious pressures between systolic and diastolic blood pressures.

2. The method of claim 1 applied to domestic felines with feline idiopathic cystitis to inhibit response to stressors including restraint.

3. The method of claim 1 applied to domestic felines as a preparatory procedure for physical examination, wound care, venipuncture, vaccination, glucose monitoring or claw trimming.

4. A method of inducing behavioral inhibition in domestic felines by placement of one or more pressure-applying clips along the feline's dorsal midline at a location selected from the group comprising:
on the mammal's neck region from C1 to C7;
in the tail region from L5 to S3;
on a tail head and successively towards a neck; and directly behind the ears; wherein sadi pressure applying clips comprise two opposable concavely shaped jaws hingedly adjoined along a first length, said two jaws close to form a skin fold loop, wherein skin structure is gathered between said two jaws such that internal surfaces of skin structure are in juxtaposition to each other and external surfaces of the mammal's skin are at interfaces of said two jaws.

5. The method of claim 4, said method further applied to domestic felines with feline idiopathic cystitis to inhibit response to stressors including restraint.

6. The method of claim 4, further applied to domestic felines as a preparatory procedure for physical examination, wound care, venipuncture, vaccination, glucose monitoring or claw trimming.
